(19) United States
(12) Patent Application Publication
(10) Pub. No.: US 2013/0029883 A1
(43) Pub. Date: Jan. 31, 2013

(54) GAS GENERATING SYSTEM FOR STIMULATION AND DELIQUIFICATION

(71) Applicants: Keith Dismuke, Katy, TX (US); Richard Nelson Fox, Katy, TX (US); Herbert Juppe, Houston, TX (US); Phillip B. Kaufman, Conroe, TX (US); Glenn S. Penny, The Woodlands, TX (US); Bill Zhou, The Woodlands, TX (US)

(72) Inventors: Keith Dismuke, Katy, TX (US); Richard Nelson Fox, Katy, TX (US); Herbert Juppe, Houston, TX (US); Phillip B. Kaufman, Conroe, TX (US); Glenn S. Penny, The Woodlands, TX (US); Bill Zhou, The Woodlands, TX (US)

(73) Assignee: CESI CHEMICAL, INC., Marlow, OK (US)

(21) Appl. No.: 13/194,587

(22) Filed: Jul. 29, 2011

(51) Int. Cl. C09K 8/62

(52) U.S. Cl. 507/219; 507/260; 507/243; 507/267; 507/265; 507/252; 507/254; 507/259; 507/255

(57) ABSTRACT

A gas generating system for use in stimulation or in deliquification/dewatering includes a foam generating agent, a foam enhancing agent and a gas generating additive. The foam generating agent is absorbed or adsorbed on a first plurality of substrates and the foam boosting agent is absorbed or adsorbed on a second plurality of substrates. The gas generating additive preferably includes an acidic component contained within a releasing mechanism container and a carbonate or bicarbonate contained within a releasing mechanism container. The use of encapsulated substrate permits the staged and targeted delivery of treatment chemicals in fractures extending from the wellbore or in the wellbore itself.

### FIELD OF THE INVENTION

The present invention generally relates to the production of petroleum and more particularly to compositions and processes for improving the recovery of hydrocarbons, that is, gas or oil (petroleum), from a subterranean geological formation using stimulation techniques such as conventional hydraulic fracturing, slickwater fracturing, or acidizing, or for well deliquification of water and/or condensate to allow reservoirs to more efficiently produce.

### BACKGROUND OF THE INVENTION

Well stimulation treatments are commonly used to initiate, enhance or restore the productivity of a well. Hydraulic fracturing is a particularly common well stimulation technique that involves the high-pressure injection of specially engineered treatment fluids into the reservoir. The high-pressure treatment fluid, which often includes polymers or gellants to viscosify, thicken, or gel the treatment fluid, causes a fracture to extend away from the wellbore into the formation (reservoir) according to the natural stresses of the formation. The polymers or gellants include natural products such as polysaccharide polymers like guar gum, guar derivatives, biopolymers, cellulose and its derivatives or synthetic polymers like polyacrylamides. Viscoelastic surfactants are also widely used instead of polymers in frac fluids. Propping agents, usually called proppants, such as grains of sand of a particular size are often mixed with the treatment fluid to keep the fracture open after the high-pressure subsides when treatment is complete. The increased permeability resulting from the stimulation operation enhances the flow of hydrocarbons into the wellbore. Proppants can include sand, glass beads, ceramic proppants, resin coated sands, resin coated ceramic proppants, on the fly coated proppants, and the like.

In many recently developed reservoirs, hydraulic fracturing is used to unlock oil and gas reserves during the completion of the well. In this way, hydraulic fracturing is no longer used only in remedial stimulation efforts. Many newly completed wells are candidates for hydraulic fracturing to optimize the initial recovery of hydrocarbons.

Slickwater fracturing involves using low viscosity fluids that have friction (drag) reducing polymers instead for this stimulation technique. Proppants are again used for this high pressure pumping technique. The stimulation technique of acidizing can be either fracture acidizing or matrix acidizing. In the first case, high pressure is used while in the second case the acid dissolves the formation matrix.

Well deliquification is another term for well dewatering that occurs in oilfield wells that have build-ups of water, hydrocarbons or condensates that need to be removed to allow hydrocarbon liquid and gas production. Basically, the velocity of the gas is not high enough to remove the water or condensate so the well will not produce (it shuts-down or dies). Another term for this build up is liquid loading. Like stimulation, well deliquification restores well productivity.

Various methods are used for deliquification including pumps, gas lift, and chemicals such as surfactants in the form of soap sticks or liquids injected downhole. These last chemical methods cause the water or condensate to foam which thereby reduces the hydrostatic head (pressure on the formation) and allows the gas to be produced.

The deliquification can occur in vertical, inclined, or horizontal wells or in parts of wells that have various inclination angles in different parts of the wellbore. Therefore, this idea could be applied more effectively than current cylindrical soap sticks which would not have a tendency to move/roll down the wellbore into the horizontal part of the well from the vertical and inclined sections of the well.

In some cases, however, conventional stimulation techniques fail to yield a significant improvement in production over an extended period. Water and condensate accumulate in gas wells and restrict production. In horizontal wells that have been hydraulically fractured, water and condensate tend to accumulate in vertical fractures, especially in horizontal sections of the wellbore. The accumulation of water and condensate in vertical fractures blocks the flow of gas or oil or condensate into the wellbore. Accordingly, there is a need for an enhanced stimulation technique that overcomes these and other deficiencies in the prior art.

### SUMMARY OF THE INVENTION

In preferred embodiments, the present invention includes a gas generating system for use in stimulation or gas well deliquification. The gas generating system preferably includes a gas generating additive, a foam generating agent and a foam enhancing agent. The gas generating additive preferably includes an acidic component contained within a releasing mechanism container alone or with a carbonate or bicarbonate contained within the same or a different releasing container. The foam generating agent is absorbed or adsorbed on a first plurality of substrates and the foam boosting agent is absorbed or adsorbed on a second plurality of substrates. If any of the above components are solids rather than liquids, they do not need to be absorbed or adsorbed first but can be directly encapsulated as solids.

In another aspect, preferred embodiments include gas generating system for use in a stimulation operation, wherein the composition includes a first plurality of substrates, wherein on each of the first plurality of substrates a foam generating chemical has been absorbed or adsorbed with and wherein each of the first plurality of substrates is encapsulated with an exterior coating. The composition further includes a second plurality of substrates, wherein on each of the second plurality of substrates a foam enhancing chemical has been absorbed or adsorbed and wherein each of the second plurality of substrates is encapsulated with an exterior coating. The foam generating chemical and the foam enhancing chemical can be encapsulated separately as noted above or mixed together before encapsulation individually.

The gas generating system optionally includes a first plurality of gas generating capsules, wherein each of the first plurality of gas generating capsules includes an acidic component encapsulated within an exterior coating and a second plurality of gas generating capsules, wherein each of the second plurality of gas generating capsules includes a carbonate or bicarbonate component encapsulated within an exterior coating.

### DETAILED DESCRIPTION OF PREFERRED EMBODIMENTS

The present invention discloses a gas generating system that includes a plurality of components that are intended to be pumped downhole during a stimulation operation or a gas well deliquification process. As used herein, the term “gas generating system” refers to the prescribed group of substrates and additives that collectively work to overcome the deficiencies of the prior art. Although the present invention is not so limited, in preferred embodiments, the gas generating system can include up to three primary components: (1) pelletized or encapsulated independent gas generators; (2) a first plurality of substrates that have been treated with foam generating chemicals; and (3) a second plurality of substrates that have been treated with foam enhancing chemicals.

For the purposes of this patent application, absorption generally refers to when atoms, molecules, or ions enter as a solid or liquid into a bulk phase—gas, liquid or solid material. As an example, a sponge (a porous media) will absorb water when the sponge is dry. Adsorption is similar, but refers to a surface rather than a volume: adsorption is a process that occurs when a gas or liquid solute accumulates on (or onto) the surface of a solid or, more rarely, a liquid (adsorbent), forming a molecular or atomic film (the adsorbate). It is different from absorption in which a substance diffuses into a liquid or solid to form a solution. The capsules, canisters or other terms used to describe the encapsulated material can release their chemicals due to crushing, melting, leaching, dissolving, defusing etc. and combinations thereof. The term “release” will refer to any or all of these delivery mechanisms.

The gas generators preferably can include an acidic component and a carbonate or bicarbonate. The carbonates and bicarbonates of the gas generating capsules include alkali metal, alkaline earth metal, and ammonium carbonates and bicarbonates. In an exemplar of the particularly preferred embodiments, the carbonate component is sodium bicarbonate. In a presently preferred embodiment, the gas generators include a first plurality of gas generating capsules that each includes an acidic component encapsulated within an exterior coating and a second plurality of gas generating capsules that each includes a carbonate or bicarbonate encapsulated within an exterior coating. During use, the encapsulation layer surrounding the acidic and carbonate or bicarbonates deteriorates, which allows the mixing of the acidic component and carbonate or bicarbonate. On mixing, the acidic component and carbonate or bicarbonate release gas, which enhances (stimulates) the creation of foam within the proppant pack and geologic fractures.

In particularly preferred embodiments, the acidic component of the gas generating capsules is selected from the group consisting of organic acids, including, but not limited to, lactic acid, acetic acid, formic acid, citric acid, oxalic acid and uric acid and also inorganic acids (mineral acids), including but not limited to hydrochloric acid, sulfuric acid, hydrofluoric acid, nitric acid, phosphoric acid, and hydrobromic acid and combinations thereof of the inorganic and organic acids, individually or together. In an exemplar of the particularly preferred embodiments, the acidic component is citric acid. The carbonate or bicarbonate of the gas generating capsules is preferably sodium carbonates or sodium bicarbonate. If the acidic component or carbonate or bicarbonate is presented in liquid form, it is necessary to separately encapsulate the acidic component and carbonate or bicarbonate to prevent the premature reaction of the gas generators. If the gas generators are provided in solid form, it may be acceptable to encapsulate the gas generators within the same coating. Suitable coatings further include not only lipids but also waxes and polymers identified below that do not deteriorate in the presence of encapsulated acids and bases, such as carbonates and bicarbonates.

An acid alone can also be used downhole in the reservoir to react with the formation. Any ester that generates acid can be used. Solid acid precursors such as lactic acid and polylactic acid may be combined with accelerators to increase the reaction and production of gas. The resulting acid dissolves carbonate formations such a limestone and dolomite to generate gas in situ.

Other gas generating chemicals include, but are not limited to, compounds containing hydrazine or azo groups, for example, hydrazine, azodicarbonamide, azobis (isobutyronitrile), p-toluene sulfonyl hydrazide, p-toluene sulfonyl semicarbazide, carbohydrazide, p-p′ oxybis (benzenesulfonylhydrazide) and mixtures thereof. Additional examples of nitrogen gas generating chemicals which do not contain hydrazine or azo groups and which are also useful in the present invention include, but are not limited to, ammonium salts of organic or inorganic acids, hydroxylamine sulfate, carbamide and mixtures thereof. Of these, azodicarbonamide or carbohydrazide are preferred. The gas generating chemical or chemicals utilized are combined with the well treating fluid in a general amount, depending on the amount of gas desired under downhole conditions, in the range of up to about 10% by weight of the treating fluid, more preferably in an amount in the range of from about 0.3% to about 8% and most preferably about 4%.

Gas generating chemicals containing hydrazide groups in which the two nitrogen atoms are connected by a single bond as well as connected to one or two hydrogens produce gas upon reaction with an oxidizing agent. It is believed that the oxidizing agent oxidizes the hydrazide group to azo structure. Therefore, hydrazide materials containing two mutually single bonded nitrogens which in turn are also bonded to one or more hydrogens need oxidizing agents for activation. To enhance the water solubility of such materials, alkaline pH is generally required. Occasionally, additional chemicals may be needed to increase the rate of gas production.

The gas generating system optionally includes a first plurality of substrates absorbed or adsorbed with foam generating (foamer) chemicals. The foam generating substrates are preferably manufactured by absorbing or adsorbing a substrate as the material with a foam generating chemical. The foam generating chemical, if it is a solid, does not need a substrate and can be encapsulated directly. The foam generating chemical is preferably a “foamer” or “soap,” which includes a surfactant component that reduces the surface tension and fluid density of the well fluid mixture (water and/or condensate) in the wellbore. Upon mixing with water and gas, foamers produce gas bubbles which lift the water or condensate from the well, thereby permitting increased production. In preferred embodiments, the foam generating chemicals include nonionic, anionic, cationic, and amphoteric/zwitterionic foaming surfactants and mixtures thereof.

Typical nonionic foaming surfactants include polyalkoxylated alcohols or phenols, in particular ethoxylated and propoxylated alcohols and phenols; ethers or esters of sugar derivatives, such as alkylpolyglucosides and alkylpolysaccharides; polyalkoxylated fatty acid esters and amides; polyalkoxylated amines; block copolymers of polyethylene oxide and polypropylene oxide; sorbitan esters; polysorbates; and polyglycerol esters of fatty acids. Typical anionic foaming surfactants include alkyl carboxylates; alkyl sulfonates; alkyl sulfates and alkyl ether sulfates; alkylbenzene sulfonates and sulfates; alkyl ether sulfonates; α-olefin sulfonates; N-acyl amino acids, such as N-acyl sarcosinates and N-acyl glutamates; N-acyl amino sulfonates, such as N-acyl taurates; acyl hydroxycarbonates; acyl hydroxysulfonates, such as acyl isethionates; mono- and dialkyl sulfocuccinates; alkyl ether sulfosuccinates; glyceryl ether solfonates; alkyl ether phosphates; and alkyl aryl ether phosphates. Cationic foaming surfactants are generally quaternary ammonium salts from alkylamines or alkanolamines with formula R¹R²R³R⁴N⁺X⁻, in which R¹, R², R³, and R⁴ are the same or different and represent an alkyl, aryl, benzyl or polyalkoxylate alkyl group. In particular, the polyalkoxylated alky group represents alkyl polyethylene oxides or alkyl polypropylene oxides. Some examples of cationic foaming surfactants include cocotrimonium chloride, stearalkonium chloride, cetyltrimonium chloride, and the like. Typical amphoteric/zwitterionic foaming surfactants include amine oxides; alkyl betaines and sulfobetaines; alkylamido betaines and sulfobetaines, such as cocamidopropyl betaine; hydroxysultaines, such as cocamidopropyl hydroxysultaine; imidazolinium betaines and sulfobetaines; amphoacetates; and amphopropionates.

Suitable foamers are available from CESI Chemical, Inc. of Marlow, Okla. under the CAP-FOAM brand and include others more fully disclosed in U.S. Pat. No. 7,122,509, entitled High Temperature Foamer Formulations for Downhole Injection, the disclosure of which is herein incorporated by reference. Other suitable foamers include OFI-4880, an ammonium C6-10 alcohol ether sulfate from Specialty Intermediates, Inc. and Harcros Foamer 846-64, polyethylene glycol mono-C6-10 alkyl ether sulfate ammonium salt available from Harcros Chemicals, Inc. of Kansas City, Kans. Alkyl ether sulfonates (AESs) are available from Oil Chem Technologies, Sugar Land, Tex., as AES-128, AES-205, AES-506, and 7-58. Sulfonates such as alpha-olefin sulfonates (AOS) with amines such as triethanaolamine (TEA) may also provide suitable foam generating components. The foam generating chemical can be a liquid, a solid, or in another composition, such as a microemulsion. Suitable microemulsions that may be used as the foam generating chemical are disclosed in U.S. Pat. No. 7,380,606, the disclosure of which is herein incorporated by reference.

The gas generating system optionally includes a second plurality of substrates absorbed or adsorbed with foam enhancing (foam booster) chemicals. In a preferred embodiment, the foam enhancer is selected from the group of anionic surfactants such as carboxylated alkyl polyglycosides, amphoteric/zwitterionic surfactants such as amine oxides, betaines, sulfobetaines, amphopropionates, hydroxysultaines, nonionic surfactants such as fatty alcohols, fatty alcohol ethoxylates, alkanolamides, and polyalkoxylated amines and cationic surfactants including quaternary amine salts. Alternatively, the foam enhancers include solvents such as mutual solvents including ethyleneglycol monobutyl ether (EGMBE) and water-soluble polymers such as hydroxypropyl guar and polyacrylamides. Examples of alkanolamides include lauric mono- and diethanolamide, myristic mono- and diethanolamide, and coconut mono- and diethanolamide. A commercially available alkanomide is Ninol CMP, coconut monoethanolamine, from Stepan Company. Examples of amine oxides include cocoamine oxide, laurylamine oxide, and cocamidopropylamine oxide. A commercially available amine oxide is Mackamine CAO, cocamidopropylamine oxide, from Rhodia.

The foam generating chemicals can often be interchanged with the foam enhancing chemicals. That is, the same chemistries can be used for both foam generation and foam enhancement. As noted above, the foam generating and foam enhancing chemicals are preferably absorbed or adsorbed on a selected substrate. Suitable substrates include proppants having a matrix which is capable of absorbing the foam generating chemical. Particularly suitable substrates include porous ceramic proppants.

Alternatively, the proppant may constitute any suitable substrate that is capable of adsorbing the foam generating chemical. Suitable adsorption substrates include finely divided minerals, fibers, ground almond shells, ground walnut shells, glass beads, and ground coconut shells. Further suitable water-insoluble adsorbents include activated carbon and/or coals, silica particulates, precipitated silicas, silica (quartz sand), alumina, silica-alumina such as silica gel, mica, silicate, e.g., orthosilicates or metasilicates, calcium silicate, sand (e.g., 20-40 mesh), bauxite, kaolin, talc, zirconia, boron and glass, including glass microspheres or beads, fly ash, zeolites, diatomaceous earth, ground walnut shells, fuller's earth and organic synthetic high molecular weight water-insoluble adsorbents. In a particularly preferred embodiment, the proppant is an ultra-lightweight proppant (ULWP) manufactured from a porous ceramic having a mesh size of 20/40. Suitable proppants are available from Carbo Ceramics of Houston, Tex., and BJ Services of Houston, Tex. (now part of Baker Hughes of Houston, Tex.) under the LiteProp™ brand name.

The lower specific gravity proppants or other substrates will allow a variety of final gas generating systems to be used that can rise into the top (upper) part of vertical factures in the horizontal section of the wellbore. Higher specific gravity gas generating systems could also be used to fall/sink into the bottom of the vertical fractures in the horizontal part of the wellbore. In a particularly preferred embodiment, mixtures of various specific gravity gas generating systems could be used to more effectively cover the entire fracture volume.

The process for absorbing or adsorbing the substrates with the foam generating chemicals or foam enhancing chemicals includes placing the substrates into the treatment chemicals and allowing the substrates to absorb or adsorb the treatment chemical, with or without pressure or vacuum. Due to the viscous nature of some of the treatment chemicals, it may be necessary to heat the treatment chemicals to permit increased absorption and adsorption into the substrate. Following processing, the substrates are preferably dried.

In particularly preferred embodiments, each of the absorbed or adsorbed substrates is encapsulated with an exterior coating to prevent the premature release or reaction of the foam generating chemical from the substrate. Delaying the release of the treatment chemicals allows for a more targeted delivery of the foam generating and foam enhancing chemicals in the hydraulic fracture. Preferred coatings include lipid coatings, hydrogenated vegetable oils, including triglycerides such as hydrogenated cottonseed, corn, peanut, soybean, palm, palm kernel, babassu, sunflower, safflower oils. Preferred hydrogenated vegetable oils include hydrogenated palm oil, cottonseed oil, and soybean oil. The most preferred hydrogenated vegetable oil is hydrogenated soybean oil. Suitable encapsulating products are available, for example but not necessarily limited to those, from Balchem Corporation of New Hampton, New York.

Alternatively, the absorbed or adsorbed substrate can be encapsulated with a suitable wax. The wax can be paraffin wax; a petroleum wax; a mineral wax such as ozokerite, ceresin, Utah wax or montan wax; a vegetable wax such as, for example, carnuba wax, Japan wax, bayberry wax or flax wax; an animal wax such as, for example, spermaceti; or an insect wax such as beeswax, Chinese wax or shellac wax. Suitable encapsulating products are available from Balchem Corporation of New Hampton, N.Y., and others.

In yet alternative preferred embodiments, the encapsulating layer may be formed with a water-soluble polymer. Suitable water-soluble polymers include polysaccharide, polylactide, polyglycolide, polyorthoester, polyaminoacid, polyactoacid, polyglycolacid, polyacrylamide, a chitosan and a mixture of these polymers. The encapsulating layer may also be formed from an oil-soluble polymer. Suitable oil-soluble polymers include polyester, polyolefins, polyethylene and mixtures thereof.

As an alternative to impregnating the foam generating and foam enhancing chemicals on a substrate, the foam generating and foam enhancing chemicals may be used in an isolated form. For example, it may be desirable to employ solid foam generating and foam enhancing chemicals with an encapsulated boundary structure to provide for a selectively delayed release of the treatment chemicals. Alternatively, it may be desirable to use an unencapsulated solid foam generating and/or foam enhancing chemical. Such solid form foam generating and enhancing products may be provided in pellets or stick forms.

The ratios of the various components within the inventive gas generating system are preferably selected based on the needs of a particular application. For example, it may be desirable to include only the foam generating substrate and foam enhancing substrate, while excluding the gas generating capsules. In other applications, it may be desirable to exclude the foam enhancing substrates while relying solely on the benefits provided by the foam generating substrates and gas generating capsules. In yet other applications, it may be desirable to employ only the foam generating substrate or only the gas generating capsules.

In a particularly preferred embodiment, the gas generating system includes between about 0 and 99% by weight of foam generating substrate, about 0 and 99% by weight of foam enhancing substrate and about 0 and 99% by weight of portions of acidic and carbonate or bicarbonate gas generating capsules. In an alternate preferred embodiment, the gas generating system includes between about 10 and 80% by weight of foam generating substrate, about 10 and 80% by weight of foam enhancing substrate and about 10 and 90% by weight of equal portions of acidic and carbonate or bicarbonate gas generating capsules. Often the ratios of the acidic and carbonate or bicarbonate gas generating capsules are about one to one, but they may vary considerably as desired for the situation.

In yet another alternate preferred embodiment, the gas generating system includes between about 15 and 80% by weight of foam generating substrate, about 20% and 80% by weight of foam enhancing substrate and about 20 and 80% by weight of portions of acidic and carbonate or bicarbonate gas generating capsules. During use, the selected gas generating system is mixed with a carrier fluid having a suitable viscosity. The carrier fluid and suspended substrates are then injected downhole, where the fracturing fluid flows into the reservoir adjacent the well. The suspended gas generating system forms within a proppant pack that prevents the expanded fractures from closing. A viscosity breaker can then be used to reduce the viscosity of the carrier fluid to facilitate removal. The gas generating system remains captured in the fractures extending from the wellbore.

Over time, exposure to the downhole environment causes the encapsulation layers covering the foam generating substrates, foam enhancer substrates and/or gas generating capsules to deteriorate. The deterioration of the exterior coatings allows the time-lapsed release of the treatment chemicals from the substrates and gas generating capsules. In a preferred embodiment, the foam generating substrates, foam enhancing substrates and gas generating capsules are configured to provide a staged release of the respective chemicals.

For example, it may be desirable to increase the thickness of the gas generating capsules to delay the mixing of the citric acid and sodium bicarbonate until after the foam generating chemicals and foam enhancing chemicals have been released and allowed to mix with the fluids in the fractured reservoir. Similarly, it may be desirable to stage the release of the foam enhancing chemicals until after the foam generating chemicals have been released. Alternatively, it may be desirable to use different encapsulation products to provide for a staged release of the various treatment chemicals. For example, it may be desirable to use a lipid coating on the foam generating substrates and foam enhancing substrates while using a more durable polymer coating on the gas generating capsules. It will be appreciated that further refinement of the staged delivery of the treatment chemicals can be accomplished by varying both the thickness and chemical composition of the encapsulation layers. Various melting point waxes, different thicknesses, different materials, and other methods can be used to vary the release time and order.

It may further be desirable to manufacture different encapsulation layers within each of the various components of the gas generating system. For example, it may be desirable to encapsulate a first portion of the foam generating substrates with a quick release coating and a second portion of the foam generating substrates with a delayed release coating. In this way, the release of foam generating chemicals from the substrate can be distributed over an extended period. Similarly, it may be desirable to distribute the release of foam enhancer chemicals and gas generating chemicals over extended periods by varying the thickness and/or chemical composition and number of the encapsulation layers of the respective foam enhancing substrates and gas generating capsules.

### EXAMPLES

### Example 1

In a blender test, 200 ml of tap water and 0.4 ml of liquid foamer (0.4 g for solid foamer) were added to a one quart Waring blender cup. After all the foamer is dissolved in the water, the foamer solution was mixed at 1600 rpm for 30 seconds. Immediately after mixing, a timer was started to establish the half-life of the foam. The foam was poured from the blender into a 1000 ml graduated cylinder quickly and foam height was measured. Half-life was recorded when 100 ml of water was seen in the bottom of the graduated cylinder. The results of this study are presented in TABLE 1 below:

TABLE 1
FOAM HEIGHT AND HALF-LIFE

| | | Foam height | Foam half-life |
|---|---|---|---|
| Foamer | Foamer type | (ml) | (seconds) |
| Nacconol ® 90G | Anionic | 970 | 398 |
| Steposol ® CA-207/ | Anionic | 820 | 332 |
| Nacconol ® 90G | | | |
| (10:1, w/w) | | | |
| Foamer LLF | Anionic | 780 | 277 |
| Mackadet ® EZ-154 | Anionic + | 760 | 352 |
| | amphoteric | | |
| Steposol ® CA-207 | Anionic | 640 | 214 |
| Mackam ® OK-50 | Amphoteric | 650 | 184 |
| Mackam ® LSB-50 | Amphoteric | 530 | 158 |
| Pluronic ® F98 | Nonionic | 440 | 130 |
| Tetronic ® 908 | Nonionic | 430 | 140 |

Foamers used:
Nacconol ® 90G, Stepan Company: Sodium dodecylbenzene sulfonate, solid, 90% active
Steposol ® CA-207, Stepan Company: alkyl ether sulfate, liquid, 60% active
Foamer LLF, Harcros Chemicals: alkyl ether sulfate, liquid, 97% active
Mackadet ® EZ-154, Rhodia: Mixture of disodium lauryl sulfosuccinate, sodium C14-16 olefin sulfonate, and lauramidopropyl betaine, solid, 100% active
Mackam ® OK-50, Rhodia: cocamidopropyl betaine, liquid, 39% active
Mackam ® LSB-50, Rhodia: lauramidopropyl hydroxysultaine, liquid, 43% active
Pluronic ® F98, BASF: difunctional block copolymer surfactant, solid, 100% active
Tetronic ® 908, BASF: tetrafunctional block copolymer surfactant, solid, 100% active

### Example 2

In a sand column test, a 6″ column (0.98″ diameter) was packed with a slurry of 20/40 mesh Ottawa sand, and encapsulated gas generator with/without encapsulated foamer (Foamer LLF [003] from Table 1 above) in tap water or tap water with 20% (v/v) of condensate with a 50.5 degree API Gravity. The packed sand column was immersed vertically in a water bath with a temperature of about 135 ° F. Water and or water condensate mixture recovered from the sand column was weighed to calculate percent fluid recovery.

The results below in Tables 2 and 3 demonstrate that encapsulated foamer helps recover more fluid in both tap water and tap water with 20% (v/v) condensate.

TABLE 2
PERCENT FLUID RECOVERY WITHOUT CONDENSATE

| | Percent fluid recovery (%) | |
|---|---|---|
| Time | Pack column with: encap. gas generator (1.0 g) and sand (100 g) | |
| (min) | Without encapsulated foamer | With encapsulated foamer (2.0 g) |
| 4 | 0 | 1.7 |
| 10 | 2.9 | 9.6 |
| 15 | 7.9 | 30.8 |
| 20 | 14.4 | 65.7 |
| 30 | 24.1 | 85.8 |
| 40 | 32.1 | 88.7 |
| 50 | 35.6 | 88.8 |
| 60 | 39.1 | 89.0 |
| 100 | 48.5 | |
| 120 | 49.2 | |

TABLE 3
PERCENT FLUID RECOVERY WITH
20% (V/V) CONDENSATE

| | Percent fluid recovery (%) | |
|---|---|---|
| | Pack column with: | |
| Time | co-encap. gas generator (1.0 g) and sand (100 g) | |
| (min) | Without encapsulated foamer | With encapsulated foamer (2.0 g) |
| 1 | 0.2 | 0.4 |
| 1.5 | 11.5 | 11.4 |
| 2 | 23.7 | 23.5 |
| 3 | 33.1 | 45.6 |
| 4 | 38.7 | 54.3 |
| 5 | 39.8 | 59.5 |
| 6 | 40.4 | 62.1 |
| 8 | 40.3 | 65.2 |
| 10 | 40.3 | 66.8 |
| 20 | 40.2 | 67.4 |

Results in Table 4 below demonstrate that the co-encapsulated gas generator gives higher percent fluid recovery than the separate gas generator. Note, based on comparison of the acid active weights, the separate generators can produce at least six times more gas than the co-encapsulated gas generator if completely reacted.

### Example 3

The advantage of using a co-encapsulated acid (citric acid) and base (sodium bicarbonate) system compared to encapsulating them separately is shown in the Table 4 below.

TABLE 4
ADVANTAGE OF CO-ENCAPSULATION OF ACID AND
BASE IN THE SAME ENCAPSULATION VS
SEPARATE ENCAPSULATED ACID AND BASE

Percent fluid recovery (%)
Pack column with: encap. gas generator,
encap. foamer (2.0 g) and sand (100 g)

| Time | Co-encapsulated | Separately encap. acid and |
|---|---|---|
| (min) | acid and base^{a} | encap. base^{b} |
| 2 | 2.8 | 9.3 |
| 4 | 6.9 | 16.8 |
| 10 | 25.7 | 29.6 |
| 15 | 64.1 | 39.5 |
| 20 | 82.5 | 50.2 |
| 25 | 85.5 | 55.0 |
| 30 | 88.0 | 65.4 |
| 40 | 88.8 | 69.7 |
| 50 | 88.8 | 71.6 |
| 60 | 88.7 | 72.8 |

^{a}Co-encapsulated acid and base: 2.0 g (58 wt % of base and 12 wt % of acid)
^{b}Encapsulated acid (50% active): 3.2 g; encapsulated base (70% active): 2.8 g

Since there is less total active material in the co-encapsulated acid and base, it does not provide as much recovery initially but does at longer times (more than 15 minutes).

### Example 4

### Absorption on Porous Media

Porous ceramic proppants with about 20% porosity made by Carbo Ceramics, Inc absorbed 18% by weight foamer at atmospheric pressure (no pressure or vacuum applied). The foamers are Specialty Intermediates OFI-4880 foamer concentrate and Harcros Foamer 846-64. A second batch was made with less loading of foamer since the final material appeared wet. 10% (wt) of heated OFI-4880 was added to the room temperature porous ceramic proppant and after 15 minutes of mixing, the foamer was absorbed into the ceramic proppant. The foamers were placed in an oven to make them less viscous and more pourable. The final product was relatively free flowing thus concluding that the foamer absorbed completely. Another sample using the same method as above was made except replacing OFI-4880 with Harcros Foamer 846-64. Again the sample was free flowing.

In addition, porous ceramic proppants (20/40) were mixed with CESI CapFoam SI in ratios of 9, 10 and 15%. After initial mixing, the 9 and 10% mixtures flowed freely.

### Example 5

### Adsorption onto Substrate

For the encapsulated foamers, we determine that the maximum amount of Foamer LLF (a viscous liquid) that can be adsorbed onto diatomaceous earth (DE) and still give free-flowing particles was about 50%.

It is clear that the present invention is well adapted to carry out its objectives and attain the ends and advantages mentioned above as well as those inherent therein. For the purposes of this disclosure and the appended claims, the term “well treatment operation” shall refer both to deliquification and stimulation operations. The phrases “loading the substrate” and “substrate has been loaded” shall refer to the process and results of: (i) of adsorbing or absorbing a selected formulation onto the substrate; or (ii) packing a solid formulation into a porous substrate. While presently preferred embodiments of the invention have been described in varying detail for purposes of disclosure, it will be understood that numerous changes may be made which will readily suggest themselves to those skilled in the art and which are encompassed within the spirit of the invention disclosed and claimed herein.

It is claimed:

1. A foam generating system for use in well treatment operations, the foam generating system comprising:
a first plurality of substrates, wherein each of the first plurality of substrates has been loaded with a foam generating chemical and wherein the each of the first plurality of substrates is encapsulated with an exterior coating;
a first plurality of gas generating capsules, wherein each of the first plurality of gas generating capsules includes an acidic component encapsulated within an exterior coating; and
a second plurality of gas generating capsules, wherein each of the second plurality of gas generating capsules includes a carbonate or bicarbonate component encapsulated within an exterior coating.

2. The foam generating system of claim 1, wherein the acidic component and the carbonate or bicarbonate component are encapsulated together within one coating.

3. The foam generating system of claim 1, wherein the acidic component is an organic acid selected from the group consisting of lactic acid, acetic acid, formic acid, citric acid, oxalic acid and uric acid.

4. The foam generating system of claim 1, wherein the carbonate or bicarbonate component is selected from the group consisting of alkali metal, alkaline earth metal, and ammonium carbonates and bicarbonates.

5. The foam generating system of claim 1, further comprising a second plurality of substrates, wherein each of the second plurality of substrates has been loaded with a foam enhancing chemical.

6. The foam generating system of claim 5, wherein each of the first and second pluralities of substrates comprise a porous media.

7. The foam generating system of claim 5, wherein each of the first and second pluralities of substrates are selected from the group consisting of finely divided minerals, fibers, ground almond shells, ground walnut shells, ground coconut shells, water-insoluble adsorbents including activated carbon and/or coals, silica particulates, precipitated silicas, silica (quartz sand), alumina, silica-alumina such as silica gel, mica, silicate, orthosilicates or metasilicates, calcium silicate, sand, bauxite, kaolin, talc, zirconia, boron and glass, glass microspheres or beads, fly ash, zeolites, diatomaceous earth, fuller's earth and organic synthetic high molecular weight water-insoluble adsorbents.

8. The foam generating system of claim 5 comprising:
between about 0 and 99% by weight of gas generating capsules;
between about 0 and 99% by weight of foam generating substrates; and
between about 0 and 99% by weight of foam enhancing substrates.

9. The foam generating system of claim 8 comprising:
between about 10 and 90% by weight of gas generating capsules;
between about 10 and 80% by weight of foam generating substrates; and
between about 10 and 80% by weight of foam enhancing substrates.

10. The foam generating system of claim 9 comprising:
between about 15 and 80% by weight of gas generating capsules;
between about 20 and 80% by weight of foam generating substrates; and
between about 20 and 80% by weight of foam enhancing substrates.

11. The foam generating system of claim 5, wherein each of the second plurality of substrates is not encapsulated with an exterior coating.

12. The foam generating system of claim 5, wherein each of the second plurality of substrates is encapsulated with an exterior coating.

13. The foam generating system of claim 12, wherein the exterior coatings of the first and second pluralities of substrates are lipid or other coatings, such as waxes and polymers.

14. The foam generating system of claim 12, wherein the exterior coatings of the first and second pluralities of substrates are partially hydrogenated vegetable oil.

15. The foam generating system of claim 12, wherein the exterior coatings on the first plurality of substrates is configured to release not later than the time the exterior coatings of the first and second pluralities of gas generating capsules release.

16. The foam generating system of claim 12, wherein the exterior coatings on the first plurality of substrates is made from multiple layers of the same or different materials with the same or different thicknesses to release before or at the same time as the exterior coatings of the first and second pluralities of gas generating capsules.

17. The foam generating system of claim 12, wherein the exterior coatings of the first plurality of substrates have a different thickness than the exterior coatings of the second plurality of substrates.

18. The foam generating system of claim 1, wherein the foam generating chemical is selected from the group consisting of nonionic, anionic, cationic, amphoteric/zwitterionic foaming surfactants, and polymers, and mixtures thereof.

19. The foam generating system of claim 1, wherein the foam generating chemical is an anionic surfactant selected from the group consisting of alkyl sulfate, alkyl ether sulfate, alkyl sulfonate, alkyl benzene sulfonate, alkyl ether sulfonate, and mixtures thereof.

20. The foam generating system of claim 1, further comprising a solid form foam enhancing chemical.

21. The foam generating system of claim 20, wherein the solid form foam enhancing chemical is encapsulated with an exterior coating.

22. The foam generating system of claim 21, wherein the foam enhancing chemical is selected from a group consisting of amphoteric/zwitterionic surfactants, anionic surfactants, nonionic surfactants, cationic surfactants, polymers, and solvents, such as mutual solvents, and mixtures thereof.

23. A method for treating a well, the method comprising the steps of:
providing a first plurality of substrates, wherein each of the first plurality of substrates has been treated with a foam generating chemical and wherein the absorbed or adsorbed substrate of each of the first plurality of substrates is encapsulated with an exterior coating;
providing a second plurality of substrates, wherein each of the second plurality of substrates has been treated with a foam enhancing chemical;
providing a first plurality of gas generating capsules, wherein each of the first plurality of gas generating capsules includes an acidic component encapsulated within an exterior coating;
providing a second plurality of gas generating capsules, wherein each of the second plurality of gas generating capsules includes a carbonate or bicarbonate encapsulated within an exterior coating;
mixing the first plurality of substrates, the second plurality of substrates, the first plurality of gas generating capsules and the second plurality of gas generating capsules into a carrier fluid to form a gas generation system; and
pumping the gas generating system into the well.

24. A foam generating system for use in a well treatment operation, the foam generating system comprising:
a foam generating component;
a foam enhancing component;
a first plurality of gas generating capsules, wherein each of the first plurality of gas generating capsules includes an acidic component encapsulated within an exterior coating; and
a second plurality of gas generating capsules, wherein each of the second plurality of gas generating capsules includes a carbonate or bicarbonate encapsulated within an exterior coating.

25. The foam generating system of claim 24, wherein the foam enhancing component comprises a solid form foam enhancing chemical.

26. The foam generating system of claim 25, wherein the solid form foam enhancing component is encapsulated with an exterior coating.

27. The foam generating system of claim 26, wherein the foam generating component comprises a first plurality of substrates, wherein each of the first plurality of substrates has been treated with a foam generating chemical.

28. The foam generating system of claim 27, wherein each of the first plurality of substrates is encapsulated with an exterior coating.

29. The foam generating system of claim 24, wherein the foam generating component comprises a solid form foam generating components.

30. The foam generating system of claim 29, wherein the solid form foam generating chemical is encapsulated within an exterior coating.

31. The foam generating system of claim 30, wherein the foam enhancing component comprises a second plurality of substrates, wherein each of the second plurality of substrates has been treated with a foam enhancing chemical.

32. The foam generating system of claim 31, wherein each of the second plurality of substrates is encapsulated with an exterior coating.
